(19) United States
(12) Patent Application Publication
(10) Pub. No.: US 2004/0021286 A1
(43) Pub. Date: Feb. 5, 2004

(54) Suspension arm arrangement for straddle-type all-terrain vehicle

(76) Inventors: Nicolas Bombardier, Sherbrooke (CA); Brian Mastine, Richmond (CA); Alain Massicotte, Orford (CA)

Correspondence Address: PILLSBURY WINTHROP, LLP, P.O. BOX 10500, MCLEAN, VA, 22102, US

(21) Appl. No.: 10/428,003

(22) Filed: May 2, 2003

Related U.S. Application Data
(60) Provisional application No. 60/376,842, filed on May 2, 2002.

(51) Int. Cl. B60G 3/04

(52) U.S. Cl. 280/124.134

(57) ABSTRACT

A suspension arm includes a pair of arm members having ends thereof configured to pivotably couple with a frame to allow for relative pivotal movement between the arm members and the frame. A pivot tube is connected directly to opposite ends of the arm members. The pivot tube defines a pivot axis. Attachment structure is connected directly to each of the pair of arm members and the pivot tube and is configured to pivotably connect with a suspension support structure extending from the frame. The attachment structure is configured such that the pivot tube axis and a suspension support axis defined by the suspension support structure intersect with one another proximate a lower portion of the pivot tube. The present invention additionally provides a straddle-type all-terrain vehicle having such a suspension arm.

The present application claims priority to U.S. Provisional Application Serial No. 60/376,842, which was filed on May 2, 2002, the entirety of which is hereby incorporated into the present application by reference.

### BACKGROUND OF THE INVENTION

1. Field of the Invention

The present invention relates to a suspension arm for an all-terrain vehicle and, more particularly, to a suspension arm for a straddle-type all-terrain vehicle.

2. Description of Related Art

Most straddle-type all-terrain vehicles (ATV's) include, in front and/or rear suspension systems thereof, singular or pairs of suspension arms (commonly referred to as “A-arms”) interconnecting the frame and respective left and right wheel assemblies. The paired A-arm suspension systems (commonly referred to as double A-arm suspension systems) include vertically spaced pairs of A-arms pivotably coupled to the frame on inward ends thereof, and an upright structure is pivotably connected to each outward end of the A-arm. The wheel assemblies are rotatably coupled on corresponding upright structures. As one of the wheel assemblies traverses an obstacle, the corresponding upright structure is moved generally vertically relative to the frame. The corresponding pair of A-arms pivot relative to the frame to provide the vertical movement of the upright structure. With a double A-arm suspension system, it is also possible to restrict or otherwise govern the pivotal movement of the upright structure corresponding to camber of the wheel by coordinating the relative geometries of the A-arms and by manipulating pivot axes thereof. However, double A-arm suspension systems pose several problems with use in an ATV. For one, since there are two A-arms used to couple each wheel assembly to the frame, the system tends to significantly increase the overall weight of the vehicle. Additionally, there is usually very little available space within an ATV, which may make configuration and arrangement of an double A-arm suspension system difficult. Furthermore, typical double A-arm suspension systems are relatively complex due to the inherent need to coordinate geometries of the A-arms with desired paths of relative movement between the wheel assemblies and frame.

Single A-arm suspension systems have been adopted for use with ATV as an alternative to double A-arm systems. A typical A-arm for a single A-arm type suspension includes a forward arm member and a rearward arm member, both of which are pivotably mounted to the frame on inward ends thereof. An upright structure is coupled to opposite ends of the arm members and includes a wheel assembly rotatably mounted thereon. When the wheel assembly encounters an obstacle, the A-arm pivots about the frame to allow the wheel assembly to traverse the obstacle. Contrary to the double A-arm type system, the upright structure does not simultaneously pivot relative to the A-arm.

Single A-arm suspension systems have proven suitable for use with straddle-type ATV's, especially since they generally require relatively less space and are lighter than conventional double A-arm systems. Additionally, single A-arm suspension systems tend to be less expensive to manufacture than double A-arm systems. However, with a single A-arm system, any load applied to the wheel assembly is carried by only the single A-arm. Therefore, the A-arms should be of a configuration that provides a sufficient degree of strength and rigidity. Of course, these characteristics are directly related to weight and cost efficiency, in that, increasing the strength and/or rigidity of the A-arms usually increases the weight and/or cost thereof, as well. The following are examples of conventional single A-arm suspension systems for straddle-type ATV's.

As shown in FIGS. 13 and 14, an A-arm 200 includes forward and rearward tubular arm members 202, 204 pivotably coupled to a frame 206 on inward ends thereof and having mounted thereto a pivot tube 208 on outward ends thereof. An upright structure 210 is mounted to the pivot tube 208 so as to allow a wheel assembly 212 to pivot about the pivot tube 208 and thereby effect steering of the ATV. The A-arm 200 also includes a transverse support member 214 extending between and rigidly connected to the arm members 202, 204. A bracket member 216 is securely attached to a top portion of the forward arm member 202. A shock absorber 218 is pivotably connected to the bracket member 216. With this arrangement, any load applied to the pivot tube 208 (via upright structure 210) is transferred to the shock absorber 218, and then to the frame 206, by the forward arm member 202. The forward arm member 202 must therefore be substantially strong and rigid. This requirement necessitates that the arm members 202, 204 be formed of relatively heavy structural members, e.g., relatively large diameter thick-walled metallic tubes.

FIGS. 15-18 illustrate another conventional A-arm used in a single A-arm suspension system for an ATV. The A-arm 220 includes a forward arm member 222, a rearward arm member 224, and a pivot tube 226. The forward and rearward arm members 222, 224 are actually formed of a singular tube that is bent, forming an arcuate portion 227 and providing both arm members from the same tube. The A-arm 220 also includes upper and lower plate members 228, 230 which are secured to the arm members 222, 224 at the arcuate portion 227 thereof and extend generally outwardly and support the pivot tube 226 opposite the arcuate portion 227. A bracket structure 232 is mounted to the upper plate member 228 spaced inwardly from the pivot tube 226. As shown in FIG. 18, a shock absorber 234 is pivotably connected to the bracket structure 232 on one end thereof and to a frame 236 of the ATV on an opposite end thereof.

The A-arm 220 has several disadvantages. First, since the arm members 222, 224 do not extend to the pivot tube 226, the upper and lower plate members 228, 230 must be formed of relatively strong and rigid material, which may serve to disadvantageously increase the weight of the A-arm 220. Additionally, a process of manufacturing the A-arm 220 is made complex, since the members are formed from a bent tube and the plate members 228, 230 are subsequently connected to the arm members via significant amounts of welding. Furthermore, the bracket structure 232 and pivot tube 226 are oriented such that an outward end portion of the A-arm 220 is subjected to a substantial degree of flexural loading. As shown, an axis SA defined by the shock absorber 234 intersects an axis PT defined by the pivot tube 226 well below the pivot tube 226. For this reason, the A-arm 220 must have a greater degree of strength built into it to prevent damage. Therefore, the arm members 222, 224 and plate members 228, 230 must be formed of relatively strong and rigid materials, which tend to increase the weight, size, and cost of the A-arm 220.

FIG. 19 illustrates one other conventional A-arm design for a single A-arm suspension system for an ATV. The A-arm 240 includes a forward arm member 242 and a rearward arm member 244. The forward and rearward arm members 242, 244 are joined to one another at outward ends thereof and have a bracket structure 246 mounted to upper portions thereof. The bracket structure 246 serves to strengthen the connection between the arm members 242, 244 and also serves to couple a shock absorber 248 thereto.

### SUMMARY OF THE INVENTION

It is one aspect of the present invention to provide an A-arm for a single A-arm suspension system for a straddle-type ATV.

It is another aspect of the present invention to provide an A-arm with a relatively simpler, more cost effective construction.

It is yet another aspect of the present invention to provide an A-arm configured to minimize flexural loads thereon.

One embodiment of the present invention provides a suspension arm for a straddle-type ATV including a pair of arm members having ends thereof configured to pivotably couple with a frame of the ATV to allow for relative pivotal movement between the arm members and the frame. A pivot tube is connected directly to opposite ends of the arm members and defines a pivot axis. Attachment structure is connected directly to each of the pair of arm members and the pivot tube and is configured to pivotably connect with a suspension support structure extending from the frame of the ATV. The attachment structure is configured such that the pivot tube axis and a suspension support axis defined by the suspension support structure intersect with one another proximate a lower portion of the pivot tube. This helps reduce the flexion in the arm.

Another embodiment of the present invention provides an ATV including a frame, an engine mounted to the frame, and a straddle seat mounted to the frame. A suspension support structure is pivotably connected at one end thereof to the frame and defines a suspension support axis. A pair of arm members have ends thereof pivotably coupled with the frame. A pivot tube is connected directly to opposite ends of the arm members and defines a pivot axis. Attachment structure is connected directly to each of the pair of arm members and the pivot tube and is pivotably connected to the suspension support structure at an opposite end of the suspension support structure. The attachment structure is configured such that the pivot tube axis and the suspension support axis intersect with one another proximate a lower portion of the pivot tube.

### BRIEF DESCRIPTION OF THE DRAWINGS

FIG. 1 is a front view of a portion of an ATV embodying principles of the present invention shown without body panels or wheel assemblies in place;

FIG. 2 is a partial perspective view of a forward portion of the ATV shown in FIG. 1;

FIG. 3 is another partial perspective view of the forward portion;

FIG. 4 is a perspective view of an A-arm according to principles of the present invention;

FIG. 5 is a partial bottom view of the A-arm shown in FIG. 4;

FIG. 6 is a top plan view of the A-arm shown in FIG. 4;

FIG. 7 is a partial plan view of a top of a pivot tube of the A-arm shown in FIG. 6;

FIG. 8 is a rear plan view of the A-arm shown in FIG. 4;

FIGS. 9 and 10 are partial perspective views of the A-arm shown in FIG. 4 showing exemplary weld locations;

FIG. 11 is a partial perspective view showing a brake fluid hose connected to a connecting structure on the A-arm;

FIG. 12 is a cross-sectional view taken about line X11-X11 in FIG. 2; and

FIGS. 13-19 illustrate conventional A-arms for respective prior art single A-arm suspension systems.

### DETAILED DESCRIPTION OF PREFERRED EMBODIMENTS

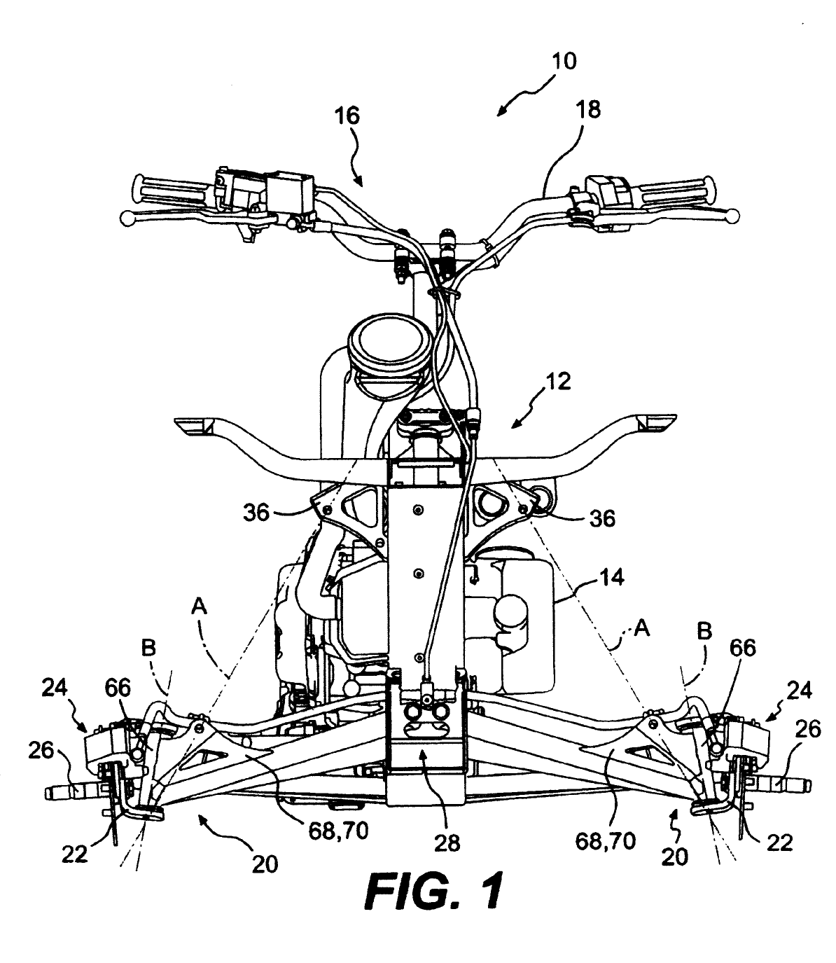

FIG. 1 shows a portion of an ATV at 10 embodying principles according to one preferred embodiment of the present invention. The ATV 10 is shown in FIG. 1 without body panels or wheel assemblies attached in order to illustrate details of the ATV 10. The ATV 10 includes a frame structure 12 on which an engine 14 is mounted to provide power for the ATV 10. The ATV 10 also includes a steering control assembly 16, e.g., a handle bar 18, to allow for steering the ATV 10. The ATV 10 includes a pair of suspension arms or A-arms 20 pivotably mounted to the frame structure 12 and extending generally laterally outwardly therefrom. Outermost ends of the A-arms 20 have upright structures 22 (e.g., yokes) pivotably mounted thereto. The upright structures 22 are also coupled to the steering control assembly 16, via a steering linkage (not shown). A rider is thus able to pivot the upright structures 22 by correspondingly pivoting the handle bar 18. Brake mechanisms 24 are coupled to the upright structures 22. The brake mechanisms 24 are shown in FIG. 1 as disk brake type brakes, however, other types of brake mechanisms may be used, such as drum brakes. The upright structures 22 also include outwardly extending shaft elements 26 mounted thereto on which the wheel assemblies are rotatably mounted.

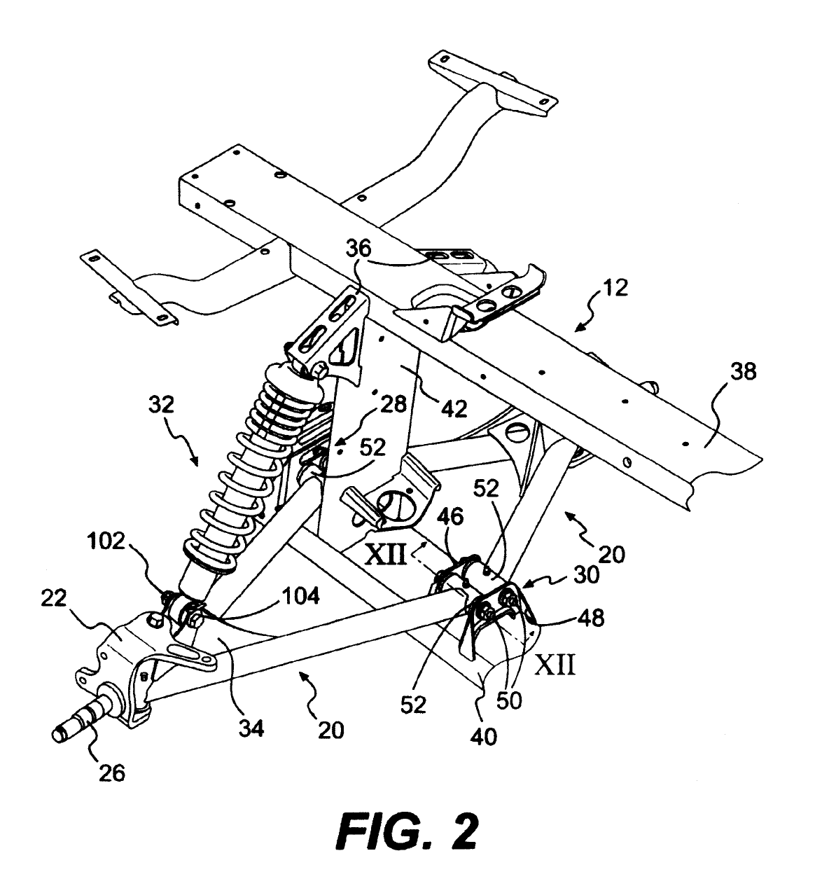

FIG. 2 shows a forward portion of the frame structure 12. As shown, the A-arms 20 are pivotably coupled to the frame structure 12 via mounting portions 28, 30, which are rigidly connected to the frame structure 12. Additionally, the A-arms 20 have a suspension support structure 32 pivotably connected thereto, which may be in the form of a shock absorber or strut. The A-arms 20 include attachment structures 34 thereon that connect to lower ends of the suspension support structures 32 proximate the outward ends of the A-arms 20. Upper ends of the suspension support structures 32 are pivotably connected to respective mounting brackets 36, which are rigidly mounted to the frame structure 12. In this manner, the suspension support structures 32 resiliently bias pivotal movement of the A-arms 20 relative to the frame structure 12.

The frame structure 12 may be of one type disclosed in U.S. application of Rasidescu et al., Ser. No. 09/824,878, filed Apr. 4, 2001, incorporated herein by reference in its entirety. It is also contemplated that the frame structure 12 may be of any conventional frame design. The frame structure 12 illustrated in the figures is simply exemplary of one possible type of frame and is not meant to be in any way limiting. The frame structure 12, as illustrated, includes a singular generally horizontally extending upper frame member 38, a singular generally horizontally extending lower frame member 40, which is generally parallel with the upper frame member 38, and a generally vertically extending singular forward cross member 42, which is generally perpendicular to the upper and lower frame members 38, 40. As shown, the mounting portions 28, 30 are mounted on an upper side of the lower frame member 40. The mounting brackets 36 are mounted on sides of the upper frame member 38 and on respective sides of the cross member 42.

The mounting portion 30 includes horizontally spaced forward and rearward mounting brackets 46, 48. Central portions of the mounting brackets 46, 48 extend generally perpendicularly relative to an upper surface of the lower frame member 40 and are parallel to one another. Lateral portions of the mounting brackets 46, 48 are oriented generally perpendicularly to the central portions thereof and extend along portions of respective sides of the lower frame member 40. Pivot pins 50, which may be in the form of bolts, extend between the mounting brackets 46, 48. Connecting portions 52 of the A-arms 20 are disposed between the mounting brackets 46, 48 and are pivotably mounted on the pivot pins 50.

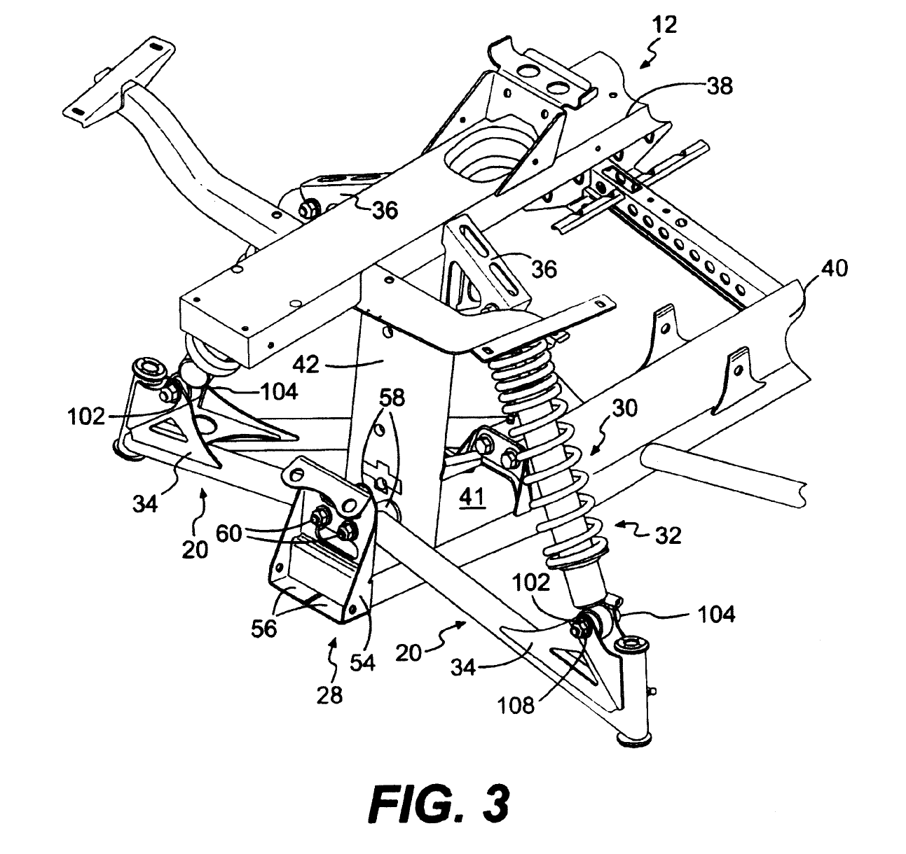

As shown in FIG. 3, the mounting portion 28 includes a forward mounting bracket 54. A central portion of the forward mounting bracket 54 extends generally perpendicularly relative to the upper surface of the lower frame member 40 and is parallel to the cross member 42. Lateral portions of the forward mounting bracket 54 are oriented generally perpendicularly to the central portion thereof and extend along respective sides of the lower frame member 40. The forward mounting bracket 54, as shown, also includes inwardly extending flange portions 56 that extend along a bottom surface of the lower frame member 40 and are fixedly mounted thereto. Connecting portions 58 are disposed between the forward mounting bracket 54 and the cross member 42 and are pivotably mounted on pivot pins 60 (e.g., bolts) extending between the forward mounting bracket 54 and cross member 42. It is also contemplated that, instead of the pivot pins 60 being connected to the cross member 42, as shown, there may be provided a rearward mounting bracket (not shown) with which the pivot pins 60 connect.

As shown in FIG. 3, a forward extent of the lower frame member 40, indicated at 41, may be slightly angled relative to a remaining extent of the lower frame member 40. In particular, the forward extent 41 may be angled slightly upwardly relative to the remaining extent of the lower frame member 40. The mounting portions 28, 30 are mounted to the lower frame member 40 along the forward extent 41 thereof. Accordingly, the A-arms 20 pivot about parallel axes which themselves are parallel to the forward extent 41 (which is angled slightly upwardly relative to the remaining extent of the lower frame member 40). The ATV 10 is configured such that the remaining extent of the lower frame member 40 is disposed generally parallel to the ground. Accordingly, since the pivot axes of the A-arms 20 are inclined relative to the ground, the A-arms are inclined relative to oncoming obstacles when the ATV 10 is moving, which orientation may allow the wheel assemblies to more effectively rise over larger obstacles. The arrangement allows the ATV 10 to more easily traverse rough terrain.

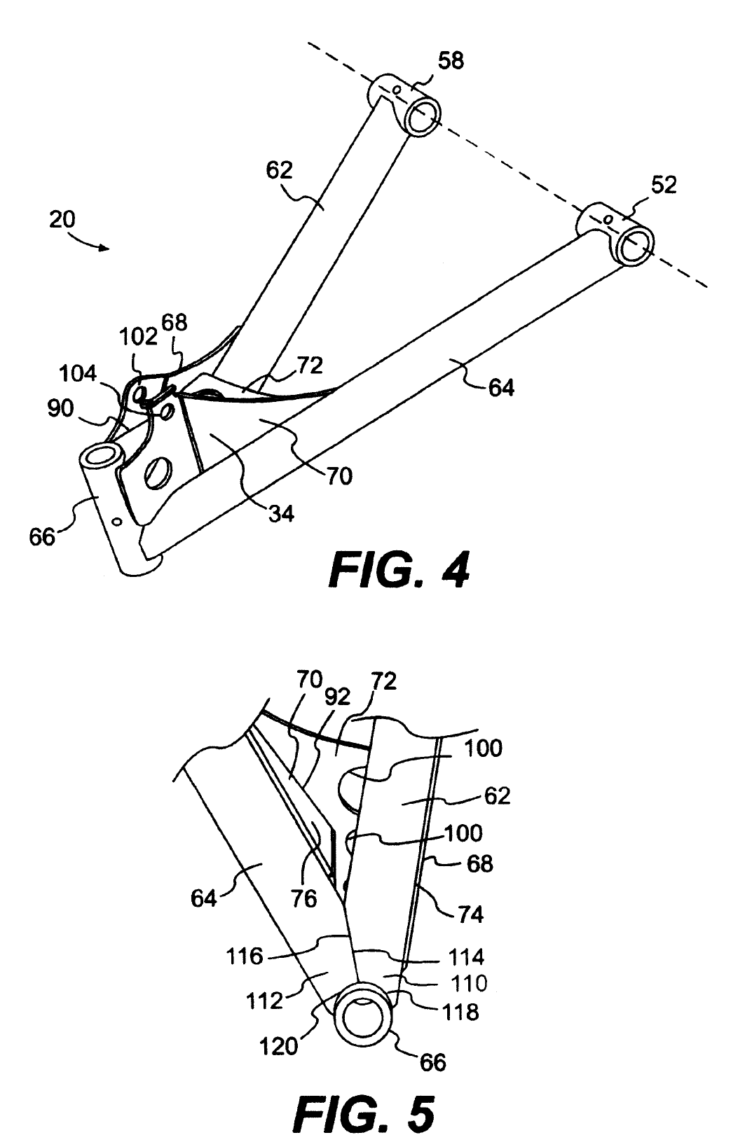

As shown in FIG. 4, each of the A-arms 20 includes a pair of arm members, in the form of a forward arm member 62 and a rearward arm member 64. The arm members 62, 64 are preferably formed from a metallic tubular material, such as tubular steel. It is contemplated that one suitable type of steel is ASTM 8607. Of course, it is possible for the arm members 62, 64 to be formed of any suitable material with any suitable configuration. For example, the arm members 62, 64 may be formed of other tubular metallic material (e.g., aluminum, titanium, any suitable alloy, etc.) or tubular or solid composite material.

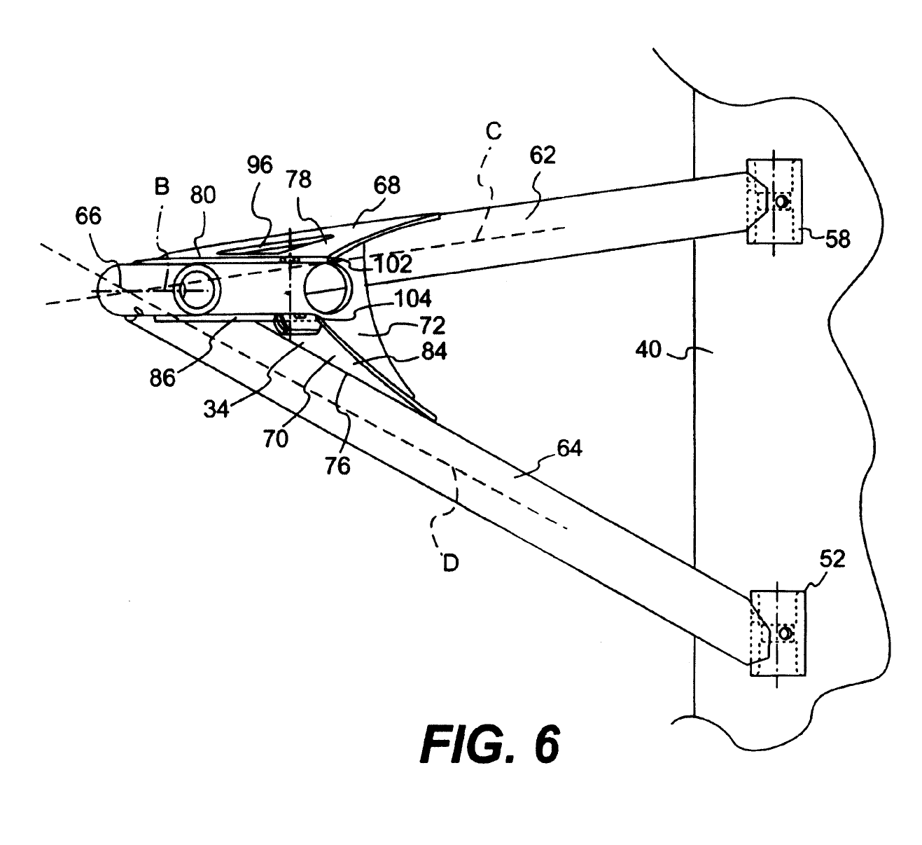

The connecting portions 52, 58 are provided at inward ends of respective arm members 62, 64. Opposite outward ends of the arm members 62, 64 are fixedly connected to a generally upstanding pivot tube 66. In this manner, the arm members 62, 64 extend generally radially outwardly from the pivot tube 66. The arm members 62, 64 may have different respective lengths. As shown, the rearward arm member 64 may be relatively longer than the forward arm member 62. Accordingly, the arm members 62, 64 are disposed at different respective angles relative to the lower frame member 40. For example, as shown in FIG. 6, the forward arm member 62 extends substantially straight outwardly (and slightly rearwardly) from the lower frame member 40 toward the pivot tube 66, while the rearward arm member 64 is disposed at a smaller angle from the lower frame member 40 and extends somewhat forwardly toward the pivot tube 66.

Preferably, the arm members 62, 64 are formed to be coplanar, such that the connecting portions 52, 58 are coaxially aligned. As shown, the attachment structure 34 includes a pair of generally upstanding bracket members 68, 70, the bracket member 68 being fixedly connected to forward arm member 62 and the pivot tube 66 and bracket number 70 being fixedly connected to rearward arm member 64 and the pivot tube 66. The attachment structure 34 additionally includes a web member 72 extending between and fixedly connected to the bracket members 68, 70. The bracket members 68, 70 and web member 72 are preferably formed of a metallic sheet material. It is contemplated that one suitable type of steel is ASTM 8715. Of course, it is possible for the bracket members 68, 70 and web member 72 to be formed of any suitable material with any suitable configuration. For example, the arm members 62, 64 may be formed of other tubular metallic material (e.g, aluminum, titanium, any suitable alloy, etc.) tubular or solid composite material or from a stamped arm made from an embossed metal sheet.

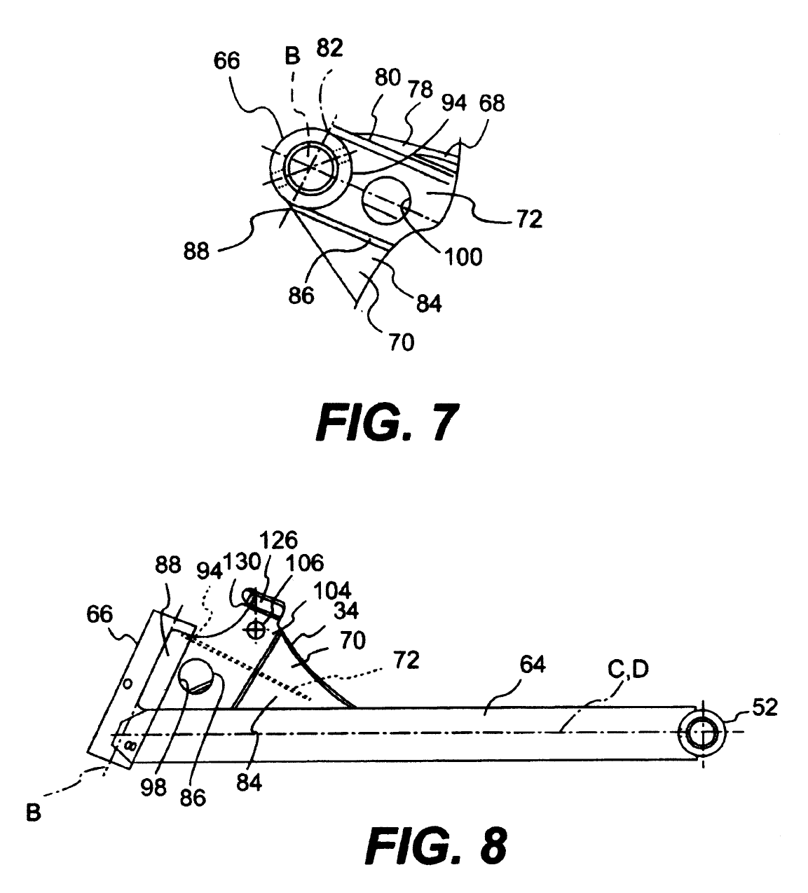

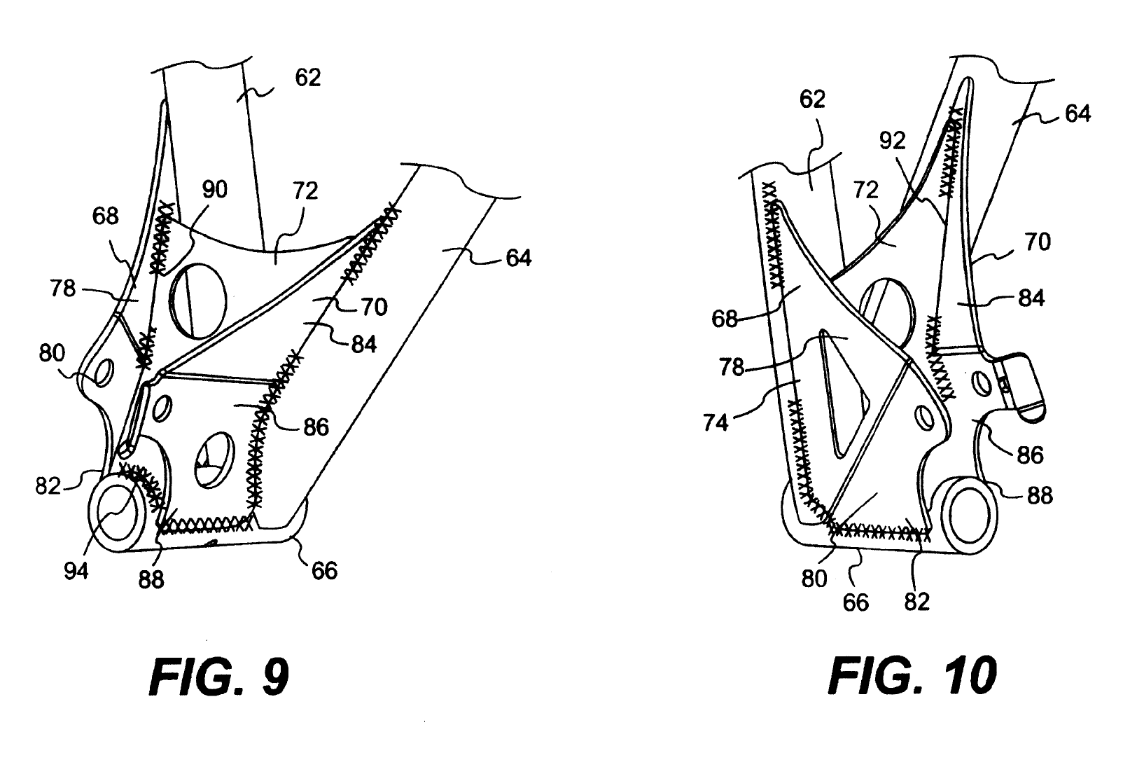

As shown in FIGS. 5 and 6, the bracket member 68 is disposed generally forwardly of the forward arm member 62. The bracket member 68 includes a pivot tube connecting portion 80 fixedly connected to the pivot tube 66. In particular, the pivot tube connecting portion 80 has an outward edge portion 82 (FIG. 9) that is configured to extend parallel to the pivot tube 66 and to extend along a leading edge portion thereof. As shown in FIG. 7, the pivot tube connecting portion 80 extends generally laterally inwardly from the edge portion 82 at a generally tangential orientation relative to the pivot tube 66. The bracket member 68 also includes an arm member connecting portion 78 that is angled generally forwardly relative to the pivot tube connecting portion 80. The arm member connecting portion 78 has an edge portion 74 that is generally adjacent the edge portion 82 of the pivot tube connecting portion 80.

Referring to FIGS. 6 and 8, the bracket member 70 is disposed generally forwardly of the rearward arm member 64. The bracket member 70 includes a pivot tube connecting portion 86 fixedly connected to the pivot tube 66. In particular, the pivot tube connecting portion 86 has an outward edge portion 88 that is configured to extend parallel to the pivot tube 66 and to extend along a trailing edge thereof, in generally diametrically opposing relation to the edge portion 82. As shown in FIG. 7, the pivot tube connecting portion 86 extends generally laterally inwardly from the edge portion 88 at a generally tangential orientation relative to the pivot tube 66. The bracket member 70 also includes an arm member connecting portion 84 that is angled generally rearwardly relative to the pivot tube connecting portion 86. As shown in FIG. 6, the arm member connecting portions 78, 84 of the bracket members 68, 70 diverge from each other toward the arm members 68, 70 corresponding to an angle between the arm members 62, 64. The arm member connecting portion 84 has an edge portion 76 that is generally adjacent the edge portion 88 of the pivot tube connecting portion 86.

As shown in FIG. 3, lower ends of the suspension support structures 32 are disposed between the pivot tube connecting portions 80, 86 of the bracket members 68, 70 and are pivotably connected thereto, as will be discussed in greater detail below.

Referring to FIGS. 6 and 7, the web member 72 is disposed between the bracket members 68, 70. The web member 72 is fixedly connected to each of the bracket members 68, 70 and to the pivot tube 66. As shown in FIG. 8, the web member 72 is connected to the pivot tube 66 proximate an upward portion thereof. As also shown, the web member 72 extends generally perpendicularly and radially outwardly from the pivot tube 66. Referring to FIG. 4, a forward edge portion 90 of the web member 72 is fixedly connected to the bracket member 68, while a rearward edge portion 92 of the web member 72 is fixedly connected to the bracket member 70. As shown in FIGS. 7 and 8, an outward edge portion 94 of the web member 72 is fixedly connected to the pivot tube 66. The outward edge portion 94 is arcuately shaped so as to abut a partial periphery of the pivot tube 66.

It is preferable for each of the bracket members 68, 70 and the web member 72 to include weight-reducing openings therein, such as shown in FIGS. 6-8 at 96, 98, 100, respectively. Referring to FIG. 6, the opening 96 within the forward bracket member 68 may be generally triangularly shaped. This particular shape maximizes the weight reduction available via the opening 96. Referring to FIG. 8, the opening 98 within the bracket member 70 may be circular so as to reduce weight of the bracket member 70 and to minimize stress within the bracket member 70. However, the opening 98 may also have any other configuration that maximizes weight reduction and prevents formation of large stress concentrations within the bracket member 70. It is also contemplated that the bracket members 68, 70 may have multiple openings formed therein. Referring to FIGS. 5 and 7, the opening 100 within the web member 72 may be circular. FIG. 5 additionally shows multiple openings 100 formed within the web member 72. The openings 100 may have any configuration that maximizes weight reduction of the web member 72, while preventing large stress concentrations therein.

As shown in FIGS. 4 and 8, the pivot tube connecting portions 80, 86 of the bracket members 68, 70 each have generally upwardly extending connecting portions 102, 104, which, as shown in FIGS. 2 and 3, are pivotably connected to lower end portions of the respective suspension support structures 32 via a connecting structure 108 (e.g., bolt and nut). In particular, the lower end of each suspension support structure 32 is disposed between connecting portions 102, 104 and the connecting structure 108 extends therethrough and through respective openings 106 formed within the connecting portions 102, 104 to connect the suspension support structures 32 to the A-arms 20. Furthermore, the bracket members 68, 70 and the pivot tube 66 are oriented such that axes, indicated at A in FIG. 1, defined by the suspension support structures 32 intersect an axis, indicated at B in FIG. 1, defined by the pivot tube 66 at a bottom portion of the pivot tube 66. Accordingly, loadings applied to the pivot tubes 66 via respective wheel assemblies are transferred directly to the suspension support structures 32 and do not effect substantial flexural loading of the arm members 62, 64 of the A-arms 20. Therefore, the arm members 62, 64 themselves and the bracket members 68, 70 may be reduced in size and weight. In this manner, the A-arms 20 may be constructed with a lower overall weight and with a simpler, more cost-effective construction process.

Referring back to FIG. 5, laterally outward end portions 110, 112 of arm members 62, 64, respectively, are configured so as to directly abut and fixedly connect to one another and to the pivot tube 66. To accomplish this, the end portions 110, 112 are formed with straight cut-out portions 114, 116 which are arranged to intersect one another at an intersection line that is oriented generally radially relative to the pivot tube 66. Additionally, the end portions 110, 112 have arcuate cut-out portions 118, 120 that cooperate to partially peripherally surround the pivot tube 66. It is preferable for the entire peripheries of the intersecting straight cut-out portions 114, 116 to be fixedly connected to one another by welding and for the arcuate cut-out portions 118, 120 to be fixedly connected to the pivot tube 66 by welding. As shown in FIGS. 6 and 8, it is also preferable for the arm members 62, 64 and the pivot tube 66 to be oriented relative to one another such that longitudinal axes C, D of the arm members 62, 64, respectively, intersect the axis B of the pivot tube 66 at the same location.

FIGS. 9 and 10 show exemplary welding locations for joining the bracket members 68, 70 to the arm members 62, 64 and to the pivot tube 66, as well as for joining the web member 72 to the pivot tube 66 and to the arm members 62, 64. In particular, it is preferable for the entire extents of the edge portions 82, 88 of the pivot tube connecting portions 80, 86 to be welded to the respective leading and trailing edge portion of the pivot tube 66. As also shown, outward and inward partial extents of the lower edge portions 74, 76 of the arm member connecting portions 78, 84 are welded to respective arm members 62, 64 such that the lower edge portions 74, 76 are disposed along leading edge portions of the arm members 68, 70. The web member 72 is preferably joined to the pivot tube 66 along the entire extent of the outer edge portion 94 thereof. Additionally, outward and inward partial extents of the forward and rearward edge portions 90, 92 of the web member 72 may be joined to respective bracket members 68, 70 by welding. Of course, any suitable welding positions may be used, including welding entire extents of the edge portions of the bracket member 68, 70 and web member 72 to the respective connecting member. However, by welding only partial extents of the edge portions, as shown in FIGS. 9 and 10, the bracket members 68, 70 and web member 72 may be joined to the respective arm members 62, 64 and pivot tube 66 with sufficient strength, while minimizing weight of the A-arms 20 due to superfluous welding.

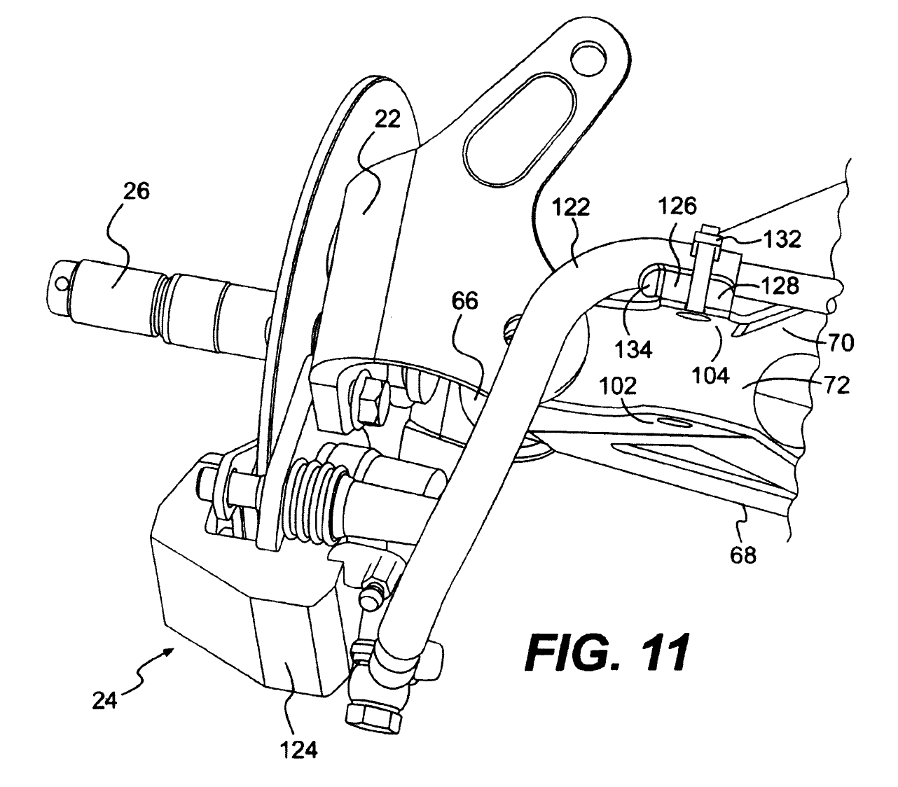

As shown in FIG. 11, the brake mechanisms 24 include a brake fluid hose 122 in fluid communication with, e.g., a caliper 124. It is contemplated that the connecting portion 104 of the bracket members 70 provides a connecting structure 126 that is configured to retain the brake fluid hose 122 thereon. In particular, the connecting structure 126 includes an arcuate flange portion 128 that abuts and partially peripherally surrounds the brake fluid hose 122. Referring to FIG. 8, the connecting structure 126 may include an opening 130 which allows a fastening device 132, such as a wire tie or hose clip, to be inserted therein and around the peripheries of the brake fluid hose 122 and the arcuate flange portion 128 to secure the brake fluid hose 122 to the connecting structure 126. As also shown in FIG. 11, the arcuate flange portion 128 may additionally provide a flared end portion 134, which prevents the brake fluid hose 122 from contacting a comer of the connecting structure 126.

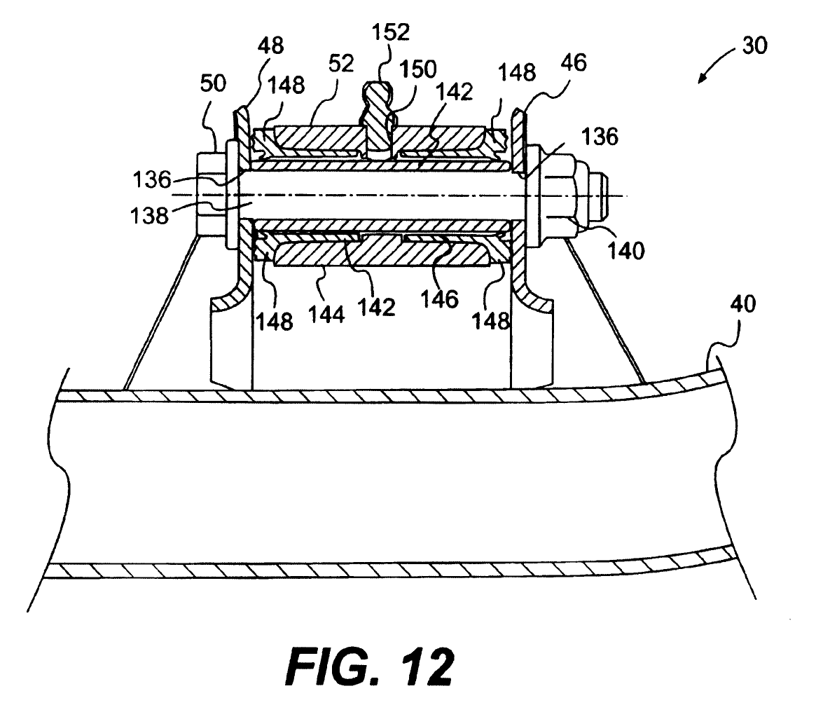

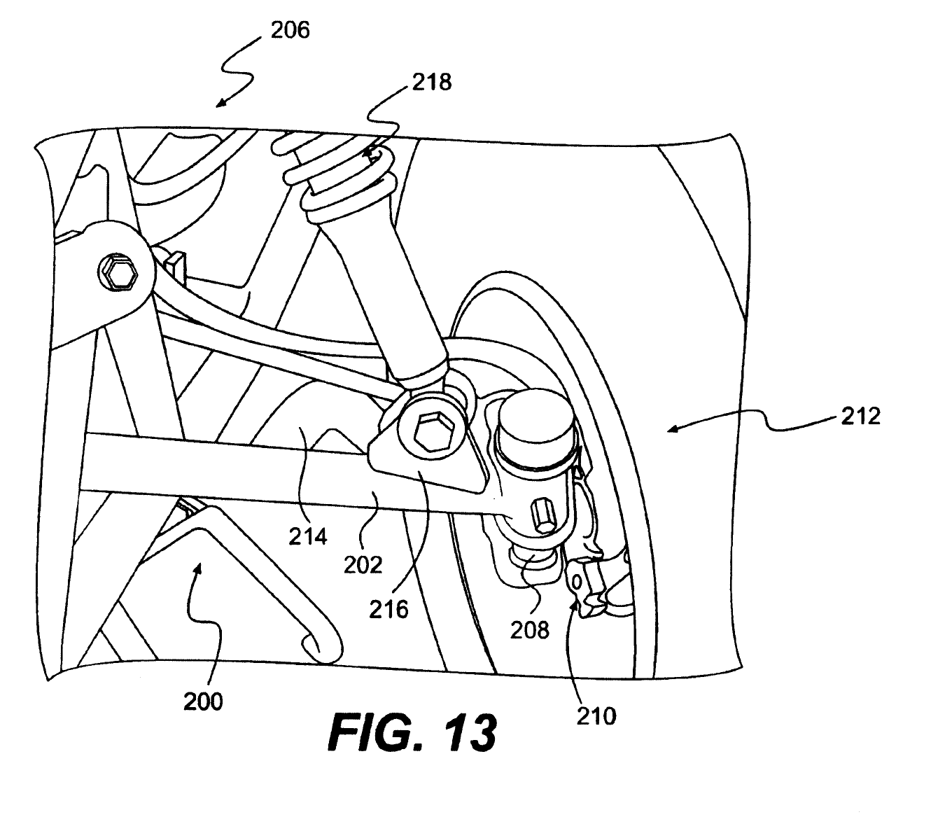

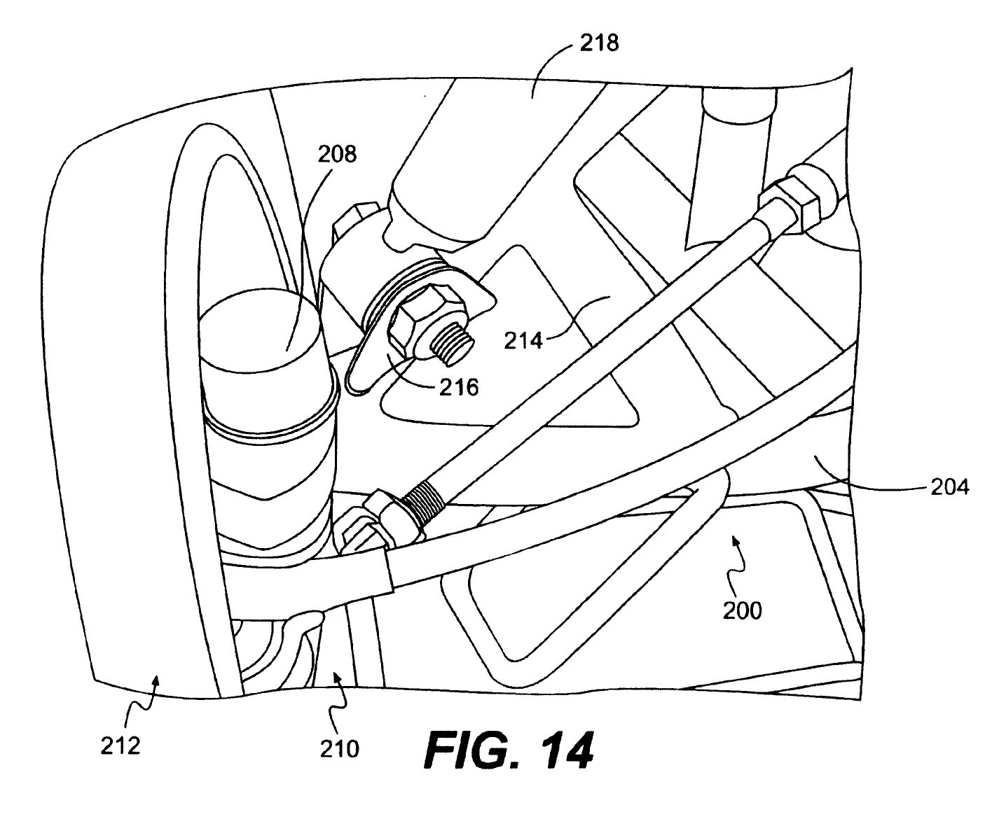

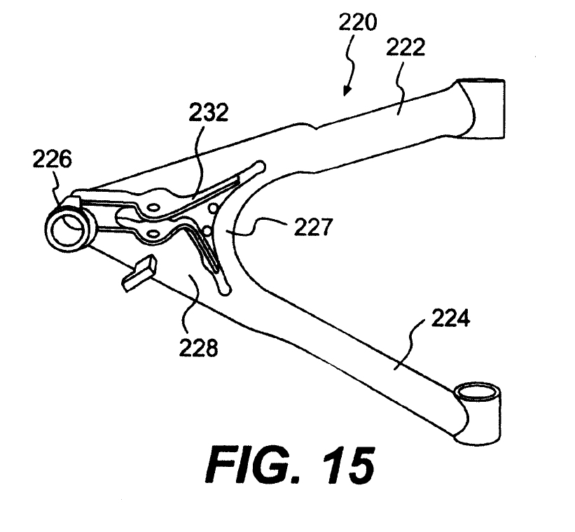

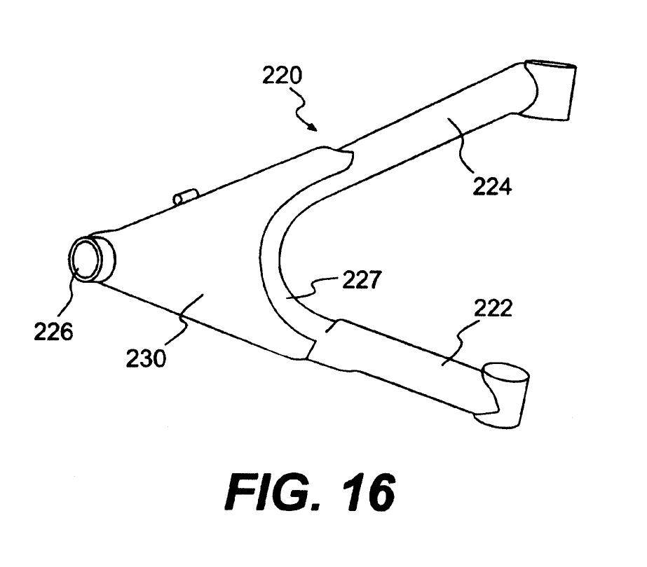

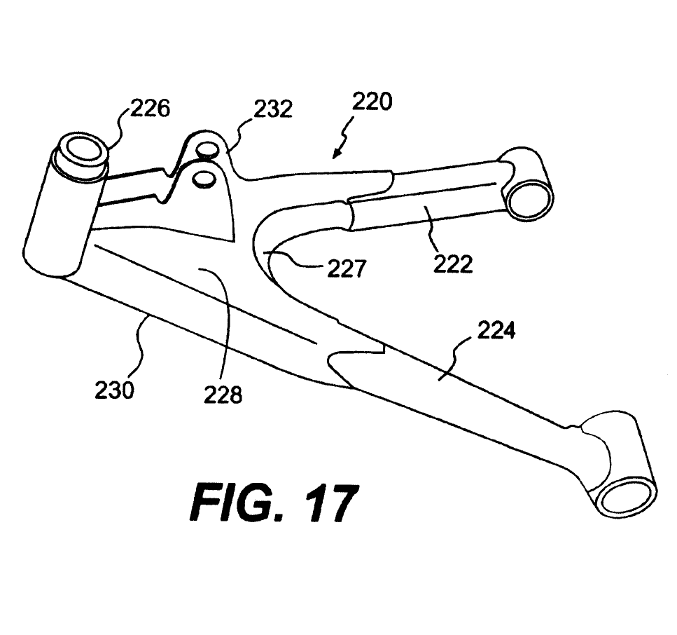

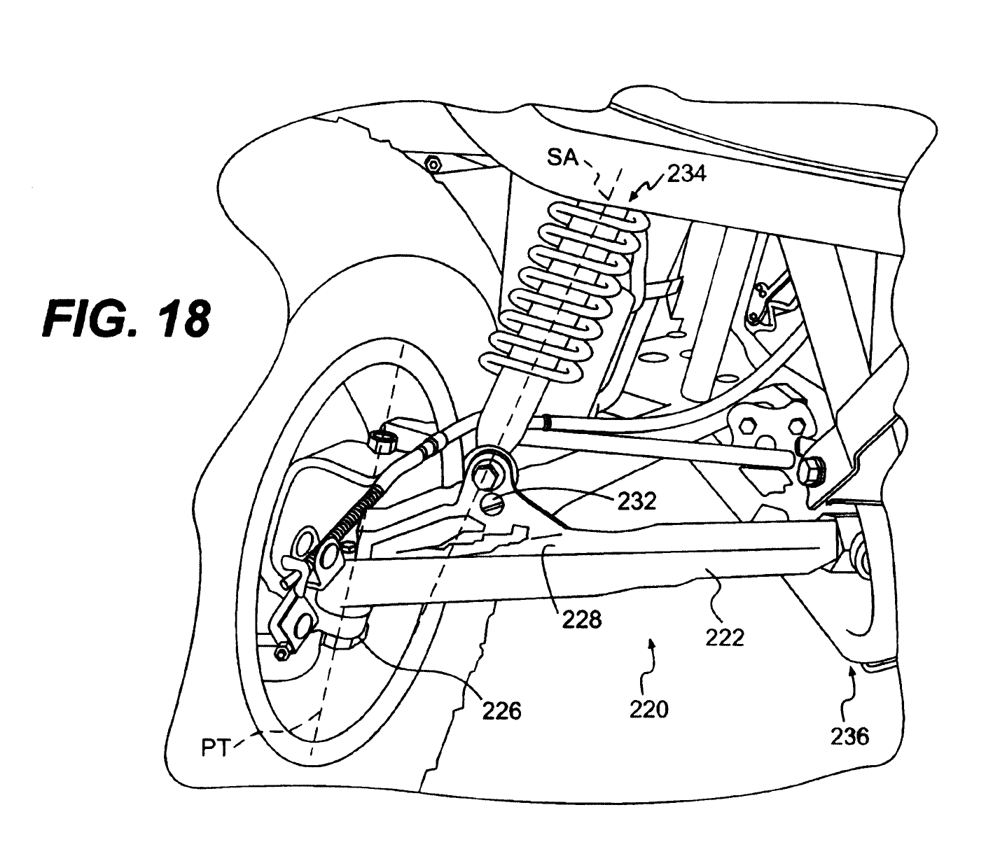

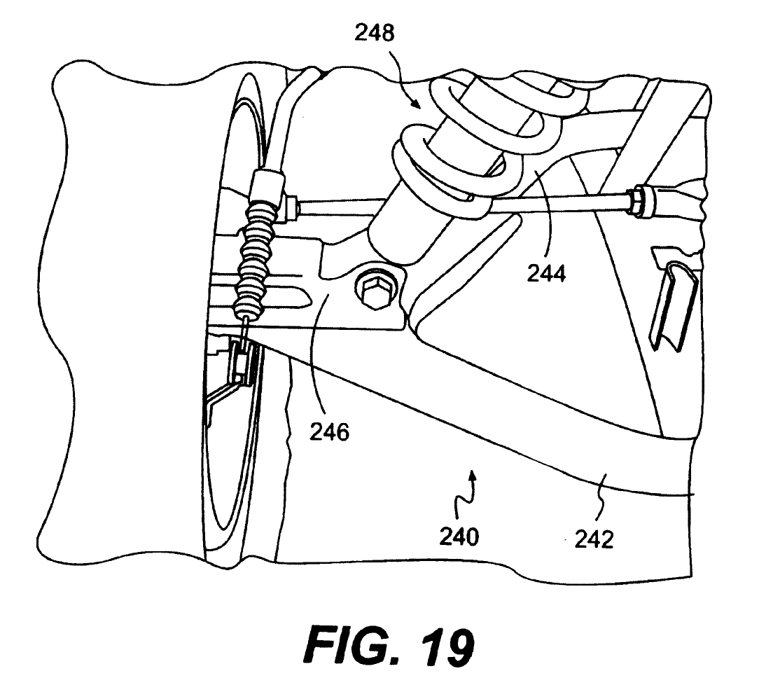

FIG. 12 illustrates further details of the mounting portion 30 and, more particularly, the pivotable connection between the arm members 62, 64 and the mounting portions 28, 30. It is also contemplated that each of the arm members 62, 64 may be pivotably coupled to the frame 12 in a manner similar to that illustrated in FIG. 12. However, with regard to mounting portion 28, the cross member 42 will be in place in lieu of the rearward mounting bracket 48.

As illustrated, each of the mounting brackets 46, 48 includes an opening 136 formed therein through which the pivot pin 50, shown in the form of a bolt 138 and nut 140, extend. A cylindrical bushing 142 is mounted concentrically on the bolt 138 between the mounting brackets 46, 48. The connecting portion 52 includes a cylindrical outer journal structure 144 with a pair of axially spaced inner journal structures 146 mounted concentrically thereon. Outer most ends of the inner journal structures 146 provide sealing structures 148 thereon. The outer journal structure 144 includes a threaded radially extending opening 150 with which a lubricant insertion member 152 is threadedly engaged so as to allow a user to apply a lubricant within an interior of the connecting portion 52. The sealing structures 148 prevent the lubricant from escaping their past.

while the principles of the present invention have been made clear in the illustrative embodiments set forth above, it will be apparent to those skilled in the art that various modifications may be made to the structure, arrangement, proportion, elements, materials, and components used in the practice of the invention.

What is claimed is:

1. A suspension arm for a vehicle comprising:
a pair of arm members having ends thereof configured to pivotably couple with a frame of the vehicle to allow for relative pivotal movement between the arm members and the frame;
a pivot tube connected directly to opposite ends of the arm members, the pivot tube defining a pivot axis; and
attachment structure connected directly to each of the pair of arm members and the pivot tube and being configured to pivotably connect with a suspension support structure extending from the frame of the vehicle, wherein
the attachment structure is configured such that the pivot tube axis and a suspension support axis defined by the suspension support structure intersect with one another proximate a lower portion of the pivot tube.

2. A suspension arm as in claim 1, wherein the attachment structure includes a pair of bracket members, each having a pair of adjacent edge portions, one of the adjacent edge portions being fixedly connected to a respective one of the pair of arm members and the other of the adjacent edge portions being fixedly connected to the pivot tube.

3. A suspension arm as in claim 2, wherein the attachment structure includes a web member extending transversely between the pair of bracket members and having opposite edge portions thereof fixedly connected to respective bracket members.

4. A suspension arm as in claim 3, wherein the web member includes another edge portion adjacent the opposite edge portions and being fixedly connected to the pivot tube.

5. A suspension arm as in claim 2, wherein each of the pair of bracket members includes a connecting portion configured to connect to the suspension support structure such that the suspension support structure is disposed therebetween.

6. A suspension arm as in claim 2, wherein one of the pair of arm members is a forward arm member and the other of the pair of arm members is a rearward arm member, the edge portion of the bracket member connected to the forward arm member being disposed in overlying relation with a leading edge portion of the forward arm member and being fixedly connected thereto, the edge portion of the bracket member connected to the rearward arm member being disposed in overlying relation with a leading edge portion of the rearward arm member and being fixedly connected thereto.

7. A suspension arm as in claim 2, wherein each of the bracket members provides an opening therein to reduce weight thereof.

8. A suspension arm as in claim 2, wherein one of the bracket members includes a connecting portion thereon configured to retain a brake fluid tube thereto.

9. A suspension arm as in claim 8, wherein the one of the bracket members provides an arcuate flange portion extending outwardly therefrom, the arcuate flange portion constituting the connecting portion.

10. A suspension arm as in claim 1, wherein each of the pair of arm members are substantially straight.

11. A suspension arm as in claim 1, wherein the pair of arm members have respective different lengths.

12. A suspension arm as in claim 1, wherein the pair of arm members are configured to extend from the frame at different angles from one another.

13. An ATV comprising:
a frame;
an engine mounted to the frame;
a straddle seat mounted to the frame;
a suspension support structure pivotably connected at one end thereof to the frame, the suspension support structure defining a suspension support axis;
a pair of arm members having ends thereof pivotably coupled with the frame;
a pivot tube connected directly to opposite ends of the arm members, the pivot tube defining a pivot axis; and
attachment structure connected directly to each of the pair of arm members and the pivot tube and being pivotably connected to the suspension support structure at an opposite end of the suspension support structure, wherein
the attachment structure is configured such that the pivot tube axis and the suspension support axis intersect with one another proximate a lower portion of the pivot tube.

14. An ATV as in claim 13, wherein the attachment structure includes a pair of bracket members, each having a pair of adjacent edge portions, one of the adjacent edge portions being fixedly connected to a respective one of the pair of arm members and the other of the adjacent edge portions being fixedly connected to the pivot tube.

15. An ATV as in claim 14, wherein the attachment structure includes a web member extending transversely between the pair of bracket members and having opposite edge portions thereof fixedly connected to respective bracket members.

16. An ATV as in claim 15, wherein the web member includes another edge portion adjacent the opposite edge portions and being fixedly connected to the pivot tube.

17. An ATV as in claim 14, wherein each of the pair of bracket members includes a connecting portion configured to connect to the suspension support structure such that the suspension support structure is disposed therebetween.

18. An ATV as in claim 14, wherein one of the pair of arm members is a forward arm member and the other of the pair of arm members is a rearward arm member, the edge portion of the bracket member connected to the forward arm member being disposed in overlying relation with a leading edge portion of the forward arm member and being fixedly connected thereto, the edge portion of the bracket member connected to the rearward arm member being disposed in overlying relation with a leading edge portion of the rearward arm member and being fixedly connected thereto.

19. An ATV as in claim 14, wherein each of the bracket members provides an opening therein to reduce a weight thereof.

20. An ATV as in claim 14, wherein one of the bracket members includes a connecting portion thereon configured to retain a brake fluid tube thereto.

21. An ATV as in claim 20, wherein the one of the bracket members provides an arcuate flange portion extending outwardly therefrom, the arcuate flange portion constituting the connecting portion.

22. An ATV as in claim 13, wherein each of the pair of arm members are substantially straight.

23. An ATV as in claim 13, wherein the pair of arm members have respective different lengths.

24. An ATV as in claim 13, wherein the pair of arm members are configured to extend from the frame at different angles from one another.

25. A suspension arm for a vehicle comprising:
a pair of arm members having first ends thereof configured to pivotably connect to a frame of the vehicle;
a pivot tube being directly fixedly connected to second ends of the pair of arm members;
a bracket member having a pair of adjacent edge portions, one of the adjacent edge portions being fixedly connected to a one of the pair of arm members and the other of the adjacent edge portions being fixedly connected to the pivot tube.

26. A suspension arm as in claim 25, further comprising an additional bracket member having a pair of adjacent edge portions, one of the adjacent edge portions being fixedly connected to the other of the pair of arm members and the other of the adjacent edge portions being fixedly connected to the pivot tube and a web member extending transversely between the bracket members and having opposite edge portions thereof fixedly connected to respective bracket members.

27. A suspension arm as in claim 26, wherein the web member includes another edge portion adjacent the opposite edge portions and being fixedly connected to the pivot tube.

28. A suspension arm as in claim 26, wherein each of the pair of bracket members includes a connecting portion configured to connect to the suspension support structure such that the suspension support structure is disposed therebetween.

29. A suspension arm as in claim 26, wherein one of the pair of arm members is a forward arm member and the other of the pair of arm members is a rearward arm member, the edge portion of the bracket member connected to the forward arm member being disposed in overlying relation with a leading edge portion of the forward arm member and being fixedly connected thereto, the edge portion of the bracket member connected to the rearward arm member being disposed in overlying relation with a leading edge portion of the rearward arm member and being fixedly connected thereto.

30. A suspension arm as in claim 25, wherein each of the pair of arm members are substantially straight.

31. A suspension arm as in claim 25, wherein the pair of arm members have respective different lengths.

32. A suspension arm as in claim 25, wherein the pair of arm members are configured to extend from the frame at different angles from one another.

33. A suspension arm as in claim 25, wherein each of the bracket members provides an opening therein to reduce a weight thereof.

34. An ATV comprising:
a frame;
an engine mounted to the frame;
a straddle seat mounted to the frame; and
the suspension arm of claim 15.
